(19) United States
(12) Patent Application Publication
(10) Pub. No.: US 2005/0031931 A1
(43) Pub. Date: Feb. 10, 2005

(54) Fuel cell system and fuel feeder

(75) Inventors: Hiroki Kabumoto, Saitama-shi (JP); Hiroko Kanai, Oura-gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 10/901,101

(22) Filed: Jul. 29, 2004

(30) Foreign Application Priority Data
Aug. 5, 2003 (JP) 2003-287146

(51) Int. Cl. H01M 8/04; B01D 19/00; B01D 53/02

(52) U.S. Cl. 429/34; 96/108; 96/155

(57) ABSTRACT

The present invention provides a safe fuel cell system. The fuel cell system comprises a fuel cell device operating with an organic liquid fuel; a fuel cartridge for feeding the organic liquid fuel to the fuel cell device; a pump for feeding the organic liquid fuel in the fuel cartridge to the fuel cell device while diluting the fuel; an air pump for feeding air to the fuel cell device; and an adsorption unit for adsorbing harmful substances generated from a reaction in the fuel cell device. For discharging a gas from the system, the gas is flown through the adsorption unit for adsorption of harmful substances and then discharged from a vent.

### BACKGROUND OF THE INVENTION

1. Field of the Invention

The present invention relates to a fuel cell system. In particular, it relates to a fuel cell system using a liquid fuel and a fuel feeder available for the fuel cell system.

2. Description of the Related Art

In recent years, a direct methanol fuel cell (DMFC) has come to attract attention as a type of fuel cell. A DMFC generates electric power by directly feeding methanol as an unreformed fuel for an electrochemical reaction between methanol and oxygen. Methanol has higher energy per a unit volume than hydrogen and is suitable for storage and relatively non-explosive. Thus, it is expected to be used in a power source for an automobile, a cellular phone or the like (See Patent Reference 1).

In a DMFC, a reaction generating carbon dioxide and hydrogen ions from methanol and water proceeds in an anode (fuel electrode), while a reaction generating water from oxygen in the air and hydrogen ions proceeds in a cathode (air electrode). In the process, chemical species such as formaldehyde, formic acid and methyl formate are formed as a reaction intermediate or byproduct in the fuel electrode side. These intermediates are formed in trace amounts, for example at most in ppm level in a DMFC for a power source in a household electrical appliance. However, since it is unallowable that an amount of a substance harmful to a human body such as formaldehyde is over a given safety standard, there is still needed a technique for minimizing a discharge of harmful substances from the system.

Patent reference 1: Japanese Laid-open Patent Publication No. 2001-185185.

### SUMMARY OF THE INVENTION

In view of the problems, an objective of the present invention is to provide a technique for realizing a safe fuel cell system.

An aspect of the present invention relates to a fuel cell system. The fuel cell comprises a fuel cell device operating with a liquid fuel and an adsorption unit for adsorbing harmful substances contained in a fluid discharged from the fuel cell device. Harmful substances such as formaldehyde formed in the fuel cell device can be adsorbed by the adsorption unit to minimize the amount of the harmful substances discharged from the system, resulting in a safe fuel cell system.

The adsorption unit may be disposed in an exhaust unit for discharging a gas from the fuel cell system. The exhaust unit has a structure for exhausting such as a tubing for discharging a gas and an outlet. An exhaust may pass through the adsorption unit before being discharged from the outlet, to reduce the amount of harmful substances discharged. The adsorption unit may be disposed in a flow line for the liquid fuel. When feeding a liquid fuel to a fuel cell device while circulating the fuel, the adsorption unit may be disposed on the circulation line so that the adsorption unit can adsorb and remove harmful substances formed in the fuel cell device during circulation.

The adsorption unit may be replaceable. When harmful substances exceeding an adsorption capacity of the adsorption unit are formed, the harmful substances may be discharged from the system without being adsorbed. However, the excessive harmful substances can be effectively adsorbed by replacing the adsorption unit. The fuel cell system may further comprise a fuel feeder for feeding a liquid fuel to the fuel cell device and the adsorption unit may be integrated with the fuel feeder. Thus, during replacing the fuel feeder, the adsorption unit can be simultaneously replaced to prevent harmful substances from being discharged from the system due to saturated adsorption capacity of the adsorption unit.

The fuel cell system may further comprise a storage unit for temporarily storing the liquid fuel fed from the fuel feeder and feeding the liquid fuel to the fuel cell device while recovering the unreacted liquid fuel from the fuel cell device for circulating the liquid fuel, and a gas contained in the storage unit may be discharged from the fuel cell system after passing through the adsorption unit.

Another aspect of the present invention relates to a fuel feeder. The fuel feeder comprises a storage unit for storing a liquid fuel; a feeding port for feeding the liquid fuel stored in the storage unit to a fuel cell device; an inlet for receiving a fluid discharged from the fuel cell device; an outlet for discharging a gas contained in the fluid; and an adsorption unit for adsorbing harmful substances in the gas.

Other aspects of the present invention include any given combination of the components described above as well as methods, apparatuses and systems among which an expression of the present invention is appropriately modified.

Moreover, this summary of the invention does not necessarily describe all necessary features so that the invention may also be sub-combination of these described features.

### BRIEF DESCRIPTION OF THE DRAWINGS

FIG. 1 shows a general structure of a fuel cell system according to Embodiment 1.

FIG. 2 shows a general structure of a fuel cell system according to Embodiment 2.

FIG. 3 shows a general structure of a fuel cell system according to Embodiment 3.

FIG. 4 shows a general structure of a fuel cell system according to Embodiment 4.

FIG. 5 shows a general structure of a fuel cell system according to Embodiment 5.

FIG. 6 shows a general structure of a fuel cell system according to Embodiment 6.

### DETAILED DESCRIPTION OF THE INVENTION

The invention will now be described based on preferred embodiments which do not intend to limit the scope of the present invention but exemplify the invention. All of the features and the combinations thereof described in the embodiments are not necessarily essential to the invention.

Embodiment 1

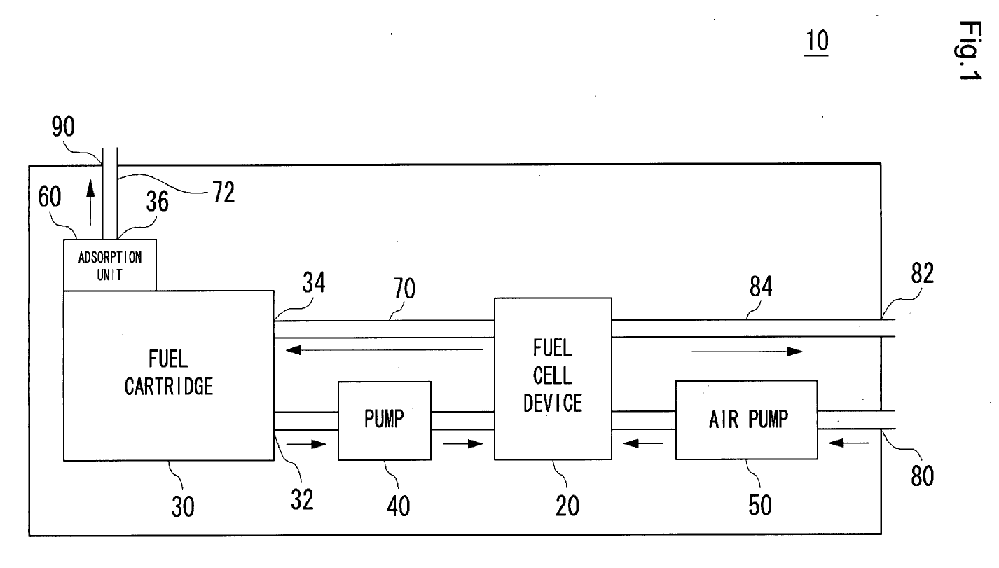

FIG. 1 shows a general structure of a fuel cell system 10 according to Embodiment 1. The fuel cell system 10 comprises a fuel cell device 20; a fuel cartridge 30 as an example of a fuel feeder for feeding a liquid fuel to the fuel cell device 20; a pump 40 for diluting the liquid fuel in the fuel cartridge 30 and feeding it to the fuel cell device 20; an air pump 50 for feeding air to the fuel cell device 20; and an adsorption unit 60 for adsorbing harmful substances. The fuel cell device 20 comprises a stack in which a plurality of a membrane electrode assemblies (hereinafter, referred to as “MEA”) consisting of a cathode and an anode layers and a proton-conductive solid polymer electrolyte film such as Nafion® between them are laminated via a conductive separator. An unreformed liquid fuel such as alcohols (e.g., methanol and ethanol) and ethers is directly fed to an anode (fuel electrode) in the MEA, while air is fed to a cathode (air electrode) of the MEA. Thus, an electrochemical reaction between the organic liquid fuel and oxygen in the MEA generates electric power.

During operation of the fuel cell system 10, an organic liquid fuel is fed from the feeding port 32 in the fuel cartridge 30 through the pump 40 to the fuel cell device 20. If a high concentration of the organic liquid fuel is directly fed to the fuel electrode in the fuel cell device 20, the organic liquid fuel may move through the solid polymer electrolyte membrane in the MEA toward the air electrode side, where the organic liquid fuel may then undergo a reaction for generating an undesirable back electromotive force. Before being fed to the fuel cell device 20, the organic liquid fuel is, therefore, diluted to an optimal concentration for effective operation of the fuel cell device 20 by feeding water from an unshown water-storage tank. A concentration sensor for detecting a concentration of the organic liquid fuel may be disposed for controlling the amount of dilution water.

In the fuel electrode in each MEA of the fuel cell device 20, the organic liquid fuel reacts with water to form carbon dioxide and hydrogen ions. The unreacted organic liquid fuel and reaction products such as carbon dioxide go back to the inlet 34 in the fuel cartridge 30 through a tubing 70. In the fuel cartridge 30, liquid and gaseous components are separated. Then, the gaseous components are discharged from the outlet 36 through the adsorption unit 60 and discharged from the system through a tubing 72 and a vent 90 as examples of an exhaust unit.

To the air electrode in each MEA in the fuel cell device 20 is fed air introduced from an intake 80 by an air pump 50. In the air electrode, oxygen in the air and hydrogen ions react to form water. The unreacted air is discharged from the system through a tubing 84 and a vent 82. The water generated by the reaction may be fed to the fuel cartridge 30 through the tubing 70; fed to a water-storage tank (not shown); or discharged from the system through a drain (not shown).

In the fuel cell device 20 of this embodiment, electric power is generated utilizing an oxidation reaction of the organic liquid fuel. An organic liquid fuel comprising carbon, hydrogen and oxygen as constituent elements such as methanol, therefore, gives carbon dioxide and water as final reaction products. In the course of the reaction, there may be, however, formed a variety of reaction intermediates. For example, it has been found that when using methanol as a fuel, an oxidation reaction of methanol gives products such as formaldehyde, formic acid and methyl formate. When a substance possibly harmful to human such as formaldehyde may be formed as a reaction intermediate, it is necessary to prevent the amount of the substance discharged from the fuel cell system 10 to the outside from exceeding a given safety standard. In terms of vapor of the organic liquid fuel, it is also necessary to devise a means of preventing the vapor from being discharged from the system in an amount exceeding a given safety standard. In this embodiment, the adsorption unit 60 is disposed upstream of the vent 90, so that harmful substances are adsorbed by the adsorption unit 60, eliminating discharge from the system. Thus, a safe fuel cell system 10 can be provided.

The adsorption unit 60 is placed for adsorbing or absorbing harmful substances in the fuel cell system 10. The adsorption unit 60 may comprise, for example, an adsorbent capable of adsorbing or absorbing materials such as formaldehyde, formic acid, methyl formate and alcohols. The adsorbent may adsorb harmful substances either physical or chemical adsorption. Examples of adsorbents which can be used include sepiolite, activated carbon, zeolite, mordenite and 2,4-diphenylhydrazine. The adsorption unit 60 may be made of a single adsorbent or a combination of two or more adsorbents. The adsorption unit 60 may selectively and exclusively adsorb a particular harmful substance or may simultaneously adsorb or absorb substances other than harmful substances. The adsorption unit 60 may convert a harmful substance to a harmless substance by a chemical reaction.

In this embodiment, the unreacted fuel in the organic liquid fuel fed to the fuel cell device 20 after being diluted by the pump 40 goes back to the fuel cartridge 30. Therefore, the organic liquid fuel in the fuel cartridge 30 becomes thinner as the system runs. When a concentration of the organic liquid fuel in the fuel cartridge 30 becomes lower than a given concentration of the fuel to be fed to the fuel cell device, the fuel cartridge 30 must be replaced. For determining the replacement timing, there may be placed a concentration sensor for detecting a concentration of the organic liquid fuel in the fuel cartridge 30. The concentration sensor may also serve as the concentration sensor for determining the amount of dilution water described above.

In this embodiment, the adsorption unit 60 and the fuel cartridge 30 are formed as an integral part for allowing the adsorption unit 60 to be replaced simultaneously with replacement of the fuel cartridge 30. Thus, it can minimize the possibility of discharging harmful substances from the system due to saturated adsorption capacity of the adsorption unit 60 after the continuous use of the unit. Furthermore, a business model will be established, where a provider of a fuel cartridge 30 collects a used fuel cartridge 30 from a user, refills with a fuel to recycle the adsorption unit 60 and then brings the fuel cartridge 30 to market. When harmful substances are physically or chemically adsorbed, an adsorbent may be heated and kept at a given temperature for a certain period to remove the adsorbed substances for recycling the adsorption unit 60. When harmful substances are absorbed by a chemical reaction, the unit may be regenerated to its original state by a chemical reaction.

The adsorption unit 60 may be not integrated with the fuel cartridge 30, but disposed at an appropriate position in a circulation line of the organic liquid fuel. In such a case, the adsorption unit 60 is also preferably replaceable. However, when the adsorption unit 60 has an adequate adsorbing capacity and the life of the adsorption unit 60 is comparable with or longer than other components in the fuel cell system 10 such as the fuel cell device 20, it does not hold true. When disposing the adsorption unit 60 in a circulating line of the organic liquid fuel, it can remove impurities such as formaldehyde, formic acid and methyl formate in the organic liquid fuel fed to the fuel cell device 20 and thus can prevent reduction of an electromotive force due to the impurities.

Embodiment 2

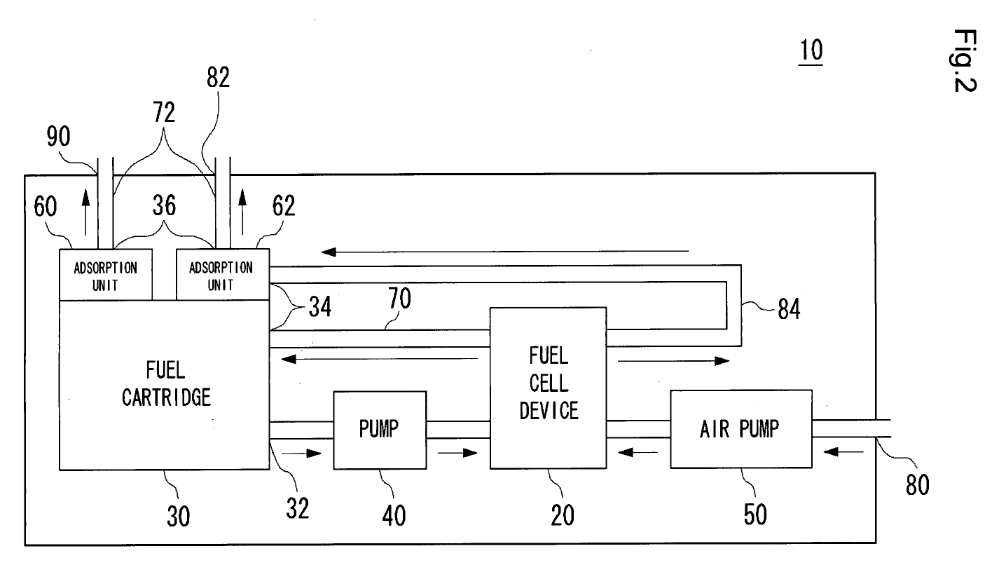

FIG. 2 shows a general structure of a fuel cell system 10 according to Embodiment 2. The fuel cell system 10 of this embodiment comprises, in addition to the fuel cell system 10 of Embodiment 1 shown in FIG. 1, an additional adsorption unit 62 in a vent 82 in the air electrode side. The other components are as described for Embodiment 1 and corresponding components are denoted by the same symbols.

As described above, an organic liquid fuel may move through a solid polymer electrolyte membrane toward the air electrode side, also generating harmful substances in the air electrode side. Therefore, in this embodiment, there is disposed the adsorption unit 62 integrally formed with the fuel cartridge 30 between a tubing 84 from the air electrode and the vent 82. It can properly treat a trace amount of harmful substances generated in the air electrode to prevent them from being discharged from the system. Thus, a safer fuel cell system 10 can be provided. The adsorption unit 62 has the same structure as that of the adsorption unit 60 described in Embodiment 1.

In this embodiment, the adsorption unit 62 is also integrally formed with the fuel cartridge 30 as is in the adsorption unit 60 for simultaneous replacement with the fuel cartridge 30. However, in another embodiment, the unit may be disposed at an appropriate position in the tubing from the fuel cell device 20 to the air vent 82. When circulating air is fed to the fuel cell device 20, the adsorption unit 62 may be disposed at an appropriate position in the circulating line.

Embodiment 3

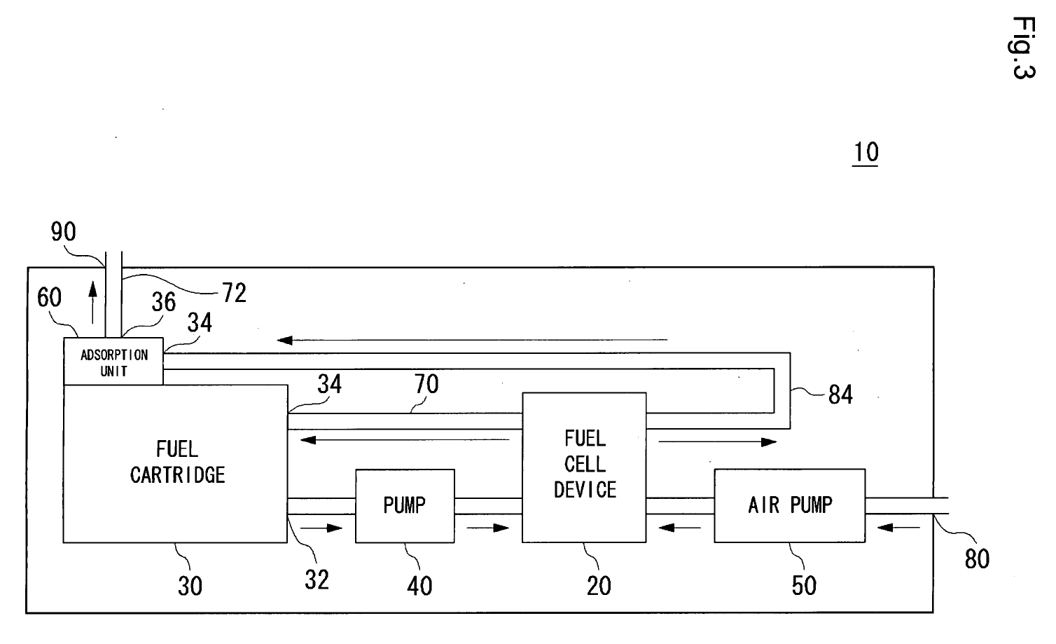

FIG. 3 shows a general structure of a fuel cell system 10 according to Embodiment 3. The fuel cell system 10 of this embodiment has a structure as described in Embodiment 2 shown in FIG. 2, except that the adsorption unit 60 also serves as the adsorption unit 62. The other components are as described for Embodiment 2 and corresponding components are denoted by the same symbols.

In this embodiment, a tubing 84 in the air electrode side is connected to the adsorption unit 60 and a gas exhausted from the air electrode in the fuel cell device 20 is discharged from a vent 90 through the adsorption unit 60. Thus, a safe fuel cell system 10 can be provided. Furthermore, since adsorption unit 60 also serves as the adsorption unit 62, the structure may be simplified to make the fuel cartridge 30 more compact and lighter.

Embodiment 4

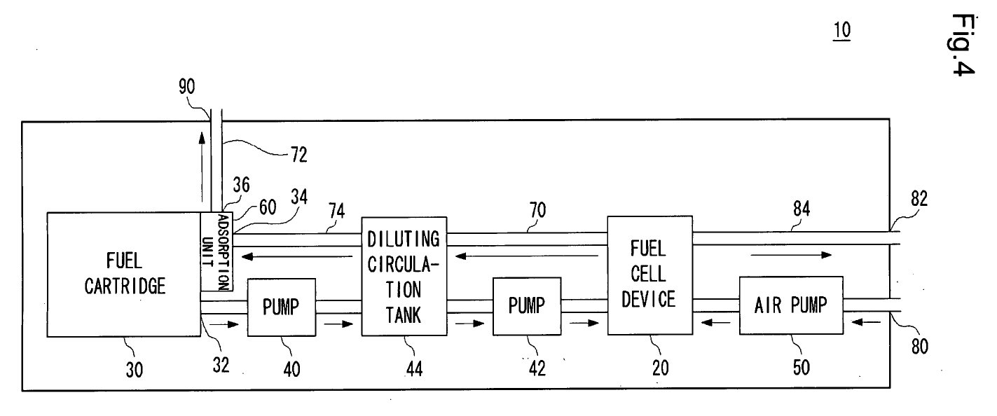

FIG. 4 shows a general structure of a fuel cell system 10 according to Embodiment 4. The fuel cell system 10 of this embodiment comprises, in addition to the fuel cell system 10 in Embodiment 1 shown in FIG. 1, a diluting circulation tank 44 as an example of a storage unit, a pump 42 and a tubing 74. The same components as those in Embodiment 1 are denoted by the same symbols.

During operation of the fuel cell system 10, a high concentration of an organic liquid fuel stored in the fuel cartridge 30 is fed to the diluting circulation tank 44 by a pump 40. In the diluting circulation tank 44, dilution water is fed from a water-storage tank (not shown) to dilute the organic liquid fuel to a given concentration. The diluted organic liquid fuel is fed to a fuel electrode in the fuel cell device 20 by a pump 42. The unreacted organic liquid fuel and carbon dioxide discharged from the fuel electrode in the fuel cell device 20 go back through a tubing 70 to the diluting circulation tank 44, where the gaseous and the liquid phases are separated. The gas is fed to an adsorption unit 60 through the tubing 74 for adsorption of harmful substances and then discharged from a vent 90. While being appropriately added from the fuel cartridge 40, the organic liquid fuel is circulated between the diluting circulation tank 44 and the fuel cell device 20.

When the organic liquid fuel in the fuel cartridge 30 is exhausted, the fuel cartridge 30 must be replaced. In this embodiment, the adsorption unit 60 and the fuel cartridge 30 are also integrally formed as in Embodiment 1 to allow the adsorption unit 60 to be replaced simultaneously with the fuel cartridge 30. Thus, the adsorption unit 60 can be periodically replaced for proper adsorption of harmful substances. In another embodiment, the adsorption unit 60 may be disposed in a circulation line of the organic liquid fuel, for example, in a diluting circulation tank 44 and a tubing 70 or in an exhaust line such as a tubing 74.

Embodiment 5

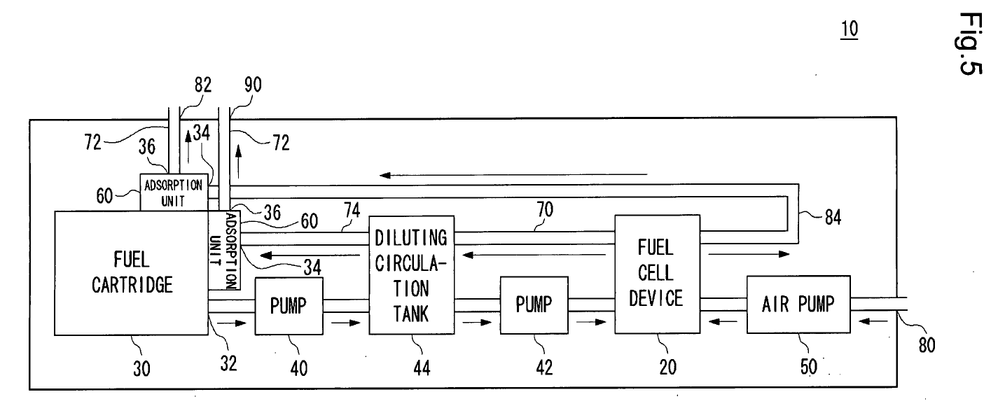

FIG. 5 shows a general structure of a fuel cell system 10 according to Embodiment 5. The fuel cell system 10 of this embodiment comprises, in addition to the fuel cell system 10 in Embodiment 4 shown in FIG. 4, an additional adsorption unit 62 in a vent 82 in the air electrode side as in Embodiment 2. The other components are as described for Embodiment 4 and corresponding components are denoted by the same symbols.

In this embodiment, the adsorption unit 62 disposed between the tubing 84 from the air electrode and the vent 82 can properly treat a trace amount of harmful substances generated in the air electrode to prevent them from being discharged from the system. Thus, a safer fuel cell system 10 can be provided.

Embodiment 6

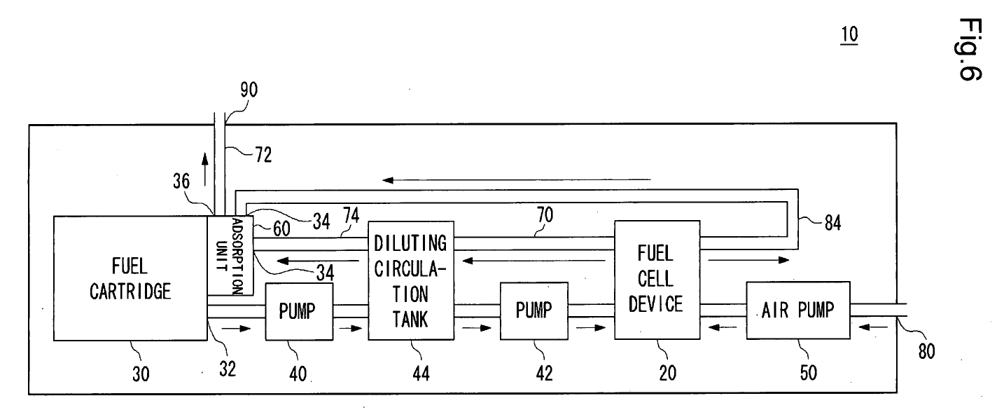

FIG. 6 shows a general structure of a fuel cell system 10 according to Embodiment 6. The fuel cell system 10 of this embodiment has a structure as described in Embodiment 5 shown in FIG. 5, except that the adsorption unit 60 also serves as the adsorption unit 62. The other components are as described for Embodiment 5 and corresponding components are denoted by the same symbols.

In this embodiment, a tubing 84 in the air electrode side is connected to the adsorption unit 60 and a gas exhausted from the air electrode in the fuel cell device 20 is discharged from a vent 90 through the adsorption unit 60. Thus, a safe fuel cell system 10 can be provided. Furthermore, since adsorption unit 60 also serves as the adsorption unit 62, the structure may be simplified to make the fuel cartridge 30 more compact and lighter.

The present invention has been described with reference to the preferred embodiments. It will be, however, understood by one skilled in the art that these embodiments are just illustrative and that there may be many variations in a combination of the components or the process steps and all of such variations are within the scope of the present invention which is defined by the appended claims.

1. A fuel cell system comprising:
a fuel cell device operating with a liquid fuel;
an adsorption unit for adsorbing harmful substances contained in a fluid discharged from the fuel cell device.

2. The fuel cell system as claimed in claim 1, wherein the adsorption unit is disposed in an exhaust unit for discharging a gas from the fuel cell system.

3. The fuel cell system as claimed in claim 1, wherein the adsorption unit is disposed in a flow line for the liquid fuel.

4. The fuel cell system as claimed in claim 1, wherein the adsorption unit is replaceable.

5. The fuel cell system as claimed in claim 1, further comprising a fuel feeder for feeding a liquid fuel to the fuel cell device, wherein the adsorption unit is integrated with the fuel feeder.

6. The fuel cell system as claimed in claim 1, further comprising:
a fuel feeder for feeding a liquid fuel to the fuel cell device, and
a storage unit for temporarily storing the liquid fuel fed from the fuel feeder and feeding the liquid fuel to the fuel cell device while recovering the unreacted liquid fuel from the fuel cell device for circulating the liquid fuel;
wherein a gas contained in the storage unit is discharged from the fuel cell system after passing through the adsorption unit.

7. A fuel feeder comprising:
a storage unit for storing a liquid fuel;
a feeding port for feeding the liquid fuel stored in the storage unit to a fuel cell device;
an inlet for receiving a fluid discharged from the fuel cell device;
an outlet for discharging a gas contained in the fluid; and
an adsorption unit for adsorbing harmful substances in the gas.
